(19) United States
(12) Patent Application Publication
(10) Pub. No.: US 2002/0153671 A1
(43) Pub. Date: Oct. 24, 2002

(54) Tunnel gasket for elevated working pressure

(75) Inventors: Ronald P. Raymond, Chagrin Falls, OH (US); William C. Andrick, Uniontown, OH (US)

Correspondence Address: Jay F. Moldovanyi, Esq., Fay, Sharpe, Fagan, Minnich & McKee, LLP, 1100 Superior Avenue, 7th Floor, Cleveland, OH, 44114-2518, US

(73) Assignee: Construction Polymers Company

(21) Appl. No.: 09/837,003

(22) Filed: Apr. 18, 2001

(51) Int. Cl. F16L 17/06

(52) U.S. Cl. 277/608

(57) ABSTRACT

A sealing member having an elongate body formed of an elastomeric material has a generally planar sealing surface adapted to provide an outward sealing force in a direction generally perpendicular to the sealing surface. The seal further includes a plurality of longitudinally extending hollow regions formed within the sealing member which are bounded at least in part by longitudinally extending and transversely spaced apart structural partitions. A layer of elastomeric material on a side opposite the sealing surface spans the structural partitions thus enclosing the hollow regions. The seals are useful in constructing segmented tunnels, ducts, and the like, and are particularly adapted to withstand high pressures.

### BACKGROUND OF THE INVENTION

The invention relates generally to the art of compression-type seals or gaskets. If finds particular application in conjunction with sealing the spaces between constructional pieces of segmented tunnels, ducts, shafts, pipes, and the like, and will be described with particular reference thereto. Exemplary such structures include subway tunnels, segmented ducts for carrying water or other media, sewer pipes, and so on. However, it is to be appreciated that the invention is equally applicable for use in other like sealed environments.

A number of seals have been developed and used for preventing the entry of water and other environmental contamination into tunnel constructions and shaft installations using segments or tube elements made of concrete, steel, steel reinforced concrete, and so forth. Conversely, such seals are also used for preventing leakage of water or other transported media out of similarly constructed segmented ducts.

Commonly, prior art seals comprise a generally planar sealing surface which contacts a like sealing surface on an adjacent facing seal to provide a sealing interference therebetween. Such seals also typically include an engaging portion disposed opposite the sealing portion which engages a mating recess formed in the lateral edge of the construction segment. While the prior art seals vary widely in configuration, the normal practice heretofore has been to form one or more grooves or channels in the recess engaging surface. While in no way intended to be an exhaustive listing, cross-sectional views of representative prior art gaskets are illustrated in FIGS. 20A-20L herein. The externally extending channels, in combination with one or more ducts formed therein, form structural partitions which are collapsible/deformable to allow the gasket to compress when adjoining segments of the construction are fastened, e.g., bolted, together. The resiliency of the gasket material results in a contact pressure between the compressed gasket pair.

It is expected that leakage between two gaskets will occur when the applied pressure approaches the gasket contact pressure. Thus, a gasket pair should theoretically be able to hold a desired water pressure if compressed sufficiently. However, it has been discovered in accordance with the subject invention that the gaskets having grooves in the recessed portion are subject to leakage at water pressures well below the gasket contact pressure. There thus exists a need in the art for an improved gasket construction which is capable of bearing higher pressures and which overcomes the above stated problems and others.

### SUMMARY OF THE INVENTION

In a first aspect of the invention, a sealing member having an elongate body formed of an elastomeric material comprises a generally planar sealing surface adapted to provide an outward sealing force in a direction generally perpendicular to the sealing surface. The sealing member further includes a plurality of longitudinally extending hollow regions formed within the sealing member which are bounded at least in part by longitudinally extending and transversely spaced apart structural partitions. A layer of elastomeric material, on a side opposite the sealing surface, spans the structural partitions thus enclosing the hollow regions.

In a second aspect of the present invention, a seal arrangement includes first and second abutting structural parts. The structural parts are segments of a type that are assembled to form a tubular tunnel with a formation of transverse joints and longitudinal joints. Each segment has a mating side and is provided on the mating side with at least one peripheral recess covering all mating sides of the segment. An elastomeric sealing member, extending in the form of an elongate body located in each recess, comprises integral first and second portions. The irst portion comprises a first sealing surface engaging a second sealing surface belonging to another sealing member located on the second structural part to provide a sealing interference therebetween. The first and second sealing surfaces are in facing relation and substantial alignment when the first structural part is secured to the second. The second portion comprises a plurality of longitudinally extending hollow regions formed within the sealing member. The hollow regions are bounded at least in part by longitudinally extending and transversely spaced apart structural partitions and a layer of elastomeric material on a side opposite the sealing surface. The layer of elastomeric material spans the structural partitions and encloses the hollow regions.

In a third aspect of the present invention, an improved method for producing a seal of a type for sealing a gap between first and second structural parts carrying a seal includes producing a elongate gasket made of an elastically compressible material comprising a generally planar sealing surface adapted to provide an outward sealing force in a direction generally perpendicular to the sealing surface, and a plurality of longitudinally extending hollow regions formed in the sealing member, the hollow regions bounded at least in part by longitudinally extending and transversely spaced apart structural partitions. A process selected from molding and extrusion is used for producing the elongate gasket. The improvement comprises producing, at the same time the elongate gasket is being produced, a layer of elastomeric material on a side opposite the sealing surface spanning the structural partitions and enclosing the hollow regions.

In a fourth aspect of the present invention, a method for increasing the sealing pressure of a seal sealing a gap between first and second structural parts is provided. The structural parts are segments of a type that are assembled to form a tubular tunnel with a formation of transverse joints and longitudinal joints. Each segment has a mating side and is provided on the mating side with at least one peripheral recess covering all mating sides of the segment. First and second sealing members are provided, each comprising first and second generally planar sealing surfaces, respectively. A plurality of longitudinally extending hollow regions are formed within the first and second sealing members. The hollow regions are bounded at least in part by longitudinally extending and transversely spaced apart structural partitions. A layer of elastomeric material is provided on the first and second sealing members, on a side opposite the sealing surface. The layer of elastomeric material spans the structural partitions and encloses the hollow regions. The first sealing member is installed on the first segment so that it is positioned within the peripheral recess thereof. The second sealing member is installed relative to the second segment in like manner. The first segment and second segments are aligned such that the first and second sealing surfaces are substantially aligned in facing relation and secured to compress the first and second sealing members and thus provide a sealing pressure between the sealing surfaces.

In a fifth aspect of the present invention, a construction article comprises a support component having a recess defined about a peripheral edge and a sealing member having an elongate body formed of an elastomeric material. The sealing member comprises a generally planar sealing surface adapted to provide an outward sealing force in a direction generally perpendicular to the sealing surface, and a plurality of longitudinally extending hollow regions formed within the sealing member, the hollow regions bounded at least in part by longitudinally extending and transversely spaced apart structural partitions. A layer of elastomeric material is disposed opposite the sealing surface and engages the recess, the layer spanning the structural partitions and enclosing the hollow regions.

One advantage of the present invention is the provision of a sealing member having superior sealing behavior as compared to open-legged seals, particularly at high pressures.

Another advantage of the present invention is found in the stability of the seals or gaskets. The seals are not as prone to failure at a contact surface between the seal and the seal engaging recess due to laterally applied pressure as are open-legged seals.

Still further benefits and advantages of the present invention will become apparent to those of ordinary skill in the art upon reading and understanding the following detailed description of the preferred embodiments.

It is to be understood that both the foregoing general description and the following detailed description are exemplary and explanatory only and are not restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The following detailed description may be best understood when read in reference to the accompanying drawings wherein similar reference characters denote similar elements throughout the several views:

FIG. 1 is a front perspective view of a pipe section formed by a plurality of tunnel pipe segments;

FIG. 2 is an enlarged fragmentary front perspective view of two annularly adjacent tunnel pipe segments with the sealing members of the invention mounted therein;

FIG. 3 is a greatly enlarged sectional view of a sealing member in accordance with a first embodiment of the invention;

FIG. 4 is an enlarged sectional view of adjacent construction segments employing the sealing member shown in FIG. 3, and wherein the sealing surfaces are in alignment;

FIG. 5 is a reduced sectional view similar to the view shown in FIG. 4, and additionally showing the placement of optional packing material in the gap between the adjacent structural segments;

FIG. 6 is a sectional view similar to the view shown in FIG. 4, but wherein the sealing surfaces are laterally offset;

FIG. 7 is a reduced sectional view of a sealing member according to a second embodiment of the invention;

FIG. 8 is a sectional view of adjacent construction segments employing the sealing member shown in FIG. 7, and wherein the sealing surfaces are in alignment;

FIG. 9 is a reduced sectional view similar to the view shown in FIG. 8, but wherein the sealing surfaces are laterally offset;

FIG. 10 is a sectional view of a sealing member according to a third embodiment of the invention;

FIG. 11 is a reduced sectional view of adjacent construction segments employing the sealing member shown in FIG. 10, and wherein the sealing surfaces are in alignment;

FIG. 12 is a sectional view similar to the view shown in FIG. 11, but wherein the sealing surfaces are laterally offset;

FIG. 13 is a sectional view of a sealing member according to a fourth embodiment of the invention;

FIG. 14 is a reduced sectional view of adjacent construction segments employing the sealing member shown in FIG. 13, and wherein the sealing surfaces are in alignment;

FIG. 15 is a sectional view similar to the view shown in FIG. 14, but wherein the sealing surfaces are laterally offset;

FIG. 16 is a sectional view of a sealing member according to a fifth embodiment of the present invention;

FIG. 17 is a sectional view of a prior art open-legged sealing member comparatively tested against the embodiment shown in FIG. 16, and which differs therefrom in that it lacks the closed base;

FIG. 18 is a graph showing load deformation curves for the gaskets shown in FIGS. 16 and 17;

FIG. 19 is a graph of water pressure, gasket contact pressure before applying water pressure, and gasket contact pressure after applying water pressure versus joint gap for water leakage tests conducted using the closed-base and open-legged gaskets of FIGS. 16 and 17, respectively; and

FIGS. 20A-20L are cross-sectional views of some representative prior art seals.

### DETAILED DESCRIPTION OF THE PREFERRED EMBODIMENTS

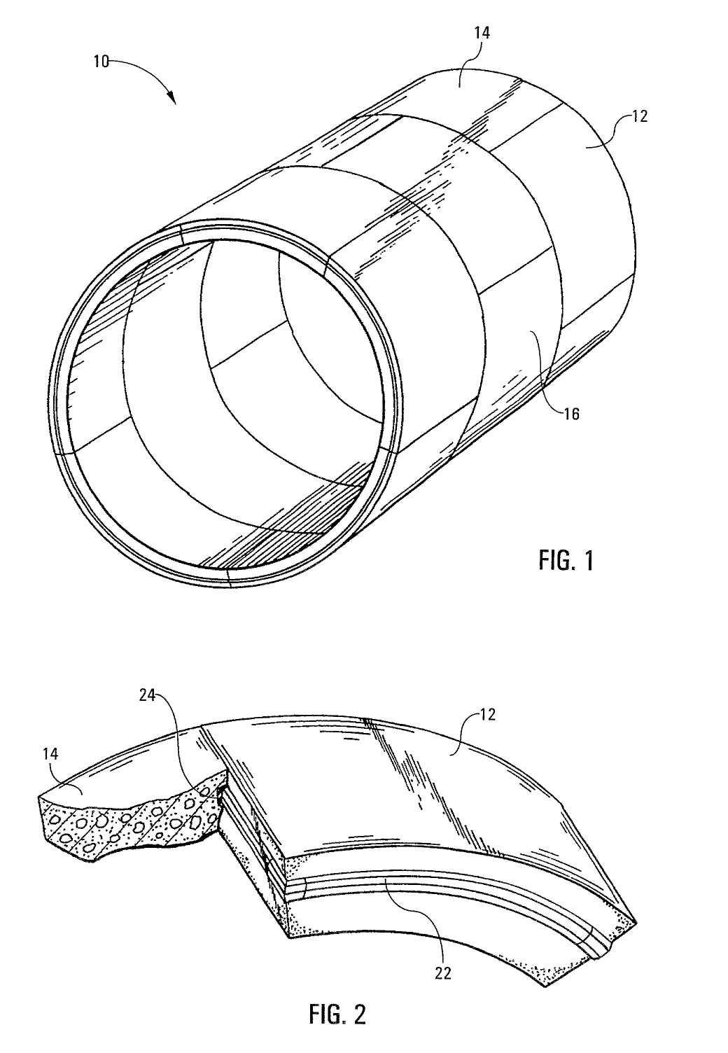

Referring to FIG. 1, a tunnel construction 10 comprises a plurality of tunnel segments, e.g., 12, 14, 16, and so forth, sealed against each other via abutting sealing members thereby forming a sealed tunnel or pipe section. FIG. 2 further illustrates a first sealing member 22 of the invention mounted onto a tunnel segment 12 and a second sealing member 24 mounted onto an adjacent tunnel segment 14. The sealing members 22 and 24 are brought into facing relation and engage each other when the tunnel segments 12 and 14 are assembled. Typically, the tunnel segments are conjoined or secured to each other using bolts or other fasteners, resulting in compression of the sealing members and thus producing a compression seal therebetween.

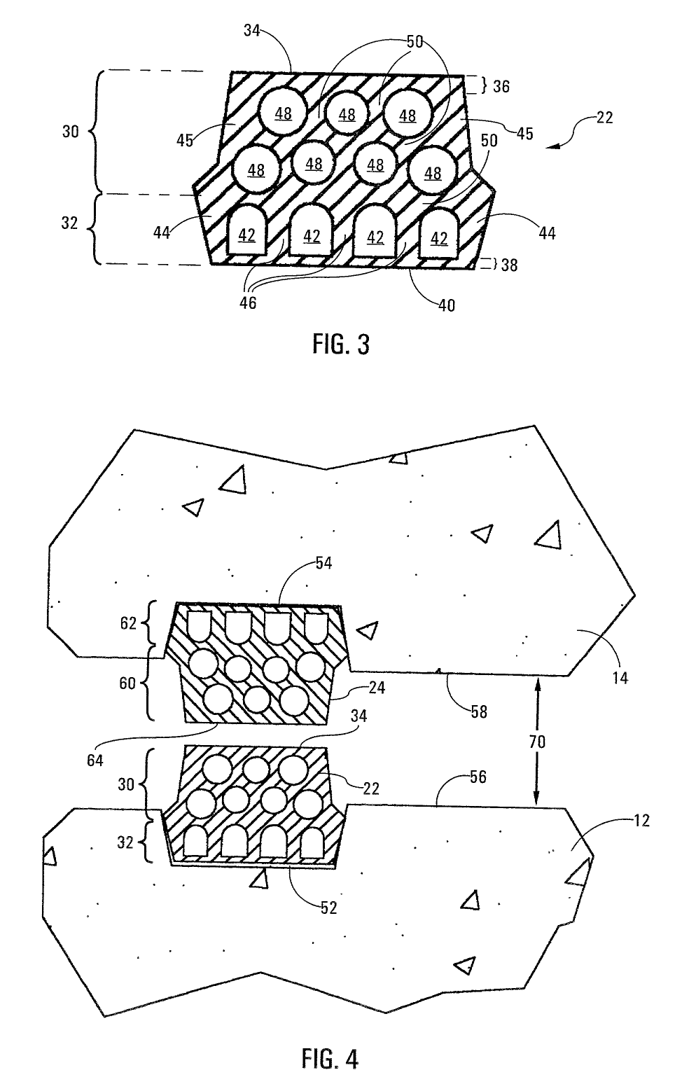

Referring now to FIG. 3, there is shown a cross-sectional view of a sealing member 22 in accordance with a first embodiment of the present invention. Seal 22 includes integral first and second portions 30 and 32, respectively. Although the seals of the present invention are described herein as comprising first and second portions, this distinction is made only for ease of exposition. It will be recognized that the subject sealing members are integrally formed and the terms “first portion” and “second portion” as used herein are not intended to preclude overlap between the two regions, particularly where hollow regions in one portion are staggered or laterally offset with respect to hollow regions in the other portion.

First portion 30 includes a sealing layer 36 having a generally planar sealing surface 34. In operation, the sealing surface 34 engages a facing sealing surface, such as surface 64 of adjacent sealing member 24 (see FIG. 4) to provide a sealing interference therebetween.

The first portion 30 further comprises a plurality of axially extending hollow regions 48 within the elongate body forming the sealing member 22. Hollow regions having circular cross-sections are shown in the depicted embodiment, although other geometrical configurations are also contemplated. The hollow regions are bounded by the lateral sides 45, sealing layer 34, and internal structural partitions 50, which are defined therearound.

Second portion 32 comprises a base layer 38 having a generally planar surface 40 which is disposed on an opposite wall of the sealing member 22 from the sealing surface 34 and aligned in a plane generally parallel therewith. The second portion 32 further comprises a plurality of laterally spaced apart and axially extending hollow regions 42. The hollow regions 42 define and are bounded by lateral side walls 44 and structural partitions 46, which are defined therearound, and are closed off by the base layer 38. The embodiment fo FIG. 3 depicts a preferred cross-sectional shape of the hollow regions 42. As shown, it is generally arch-shaped wherein the curved portion is on the side closest to the sealing surface. That is to say, hollow regions 42 have a closed U-shaped cross-section, which is inverted in the orientation depicted. Other geometrical cross-sectional configurations are contemplated as well.

The sealing members of the invention are formed by extruding or molding a resilient, compressible, elastic, or flexible material, with the hollow regions 42 and 48 and the base layer 38 being formed directly during the manufacturing process. The material forming the sealing members may be, for example, a synthetic or natural elastomeric or rubber material. Exemplary elastomeric materials which may be used in making the sealing members of the invention include, but are not limited to, polyisoprene, neoprene, butadiene-acrylonitrile copolymers, ethylene-butadiene block copolymers, ethylene-propylene based copolymers, natural rubber, polychloroprene rubber, polyisoprene-isobutylene copolymers, silicone rubber, styrene-acrylonitrile copolymers, styrene-butadiene copolymers, styrene-maleic anhydride copolymers, and so forth. The preferred materials are polyisoprene and neoprene.

Referring now to FIG. 4, there is shown a pair of adjacent support components 12 and 14, having grooves or recesses 52 and 54, respectively, formed about peripheral or lateral edges 56 and 58, respectively. The lower portion 32 of seal 22 is affixed within recess 52, preferably using glue or other adhesive. A corresponding portion 62 of seal 24 engages recess 54 in like manner. Although the groove dimensions may vary somewhat, some or all of the second region 32 is contained within the recess, and some or all of the first region 30 protrudes from the recess, when the sealing member is affixed within the recess and is in its uncompressed state.

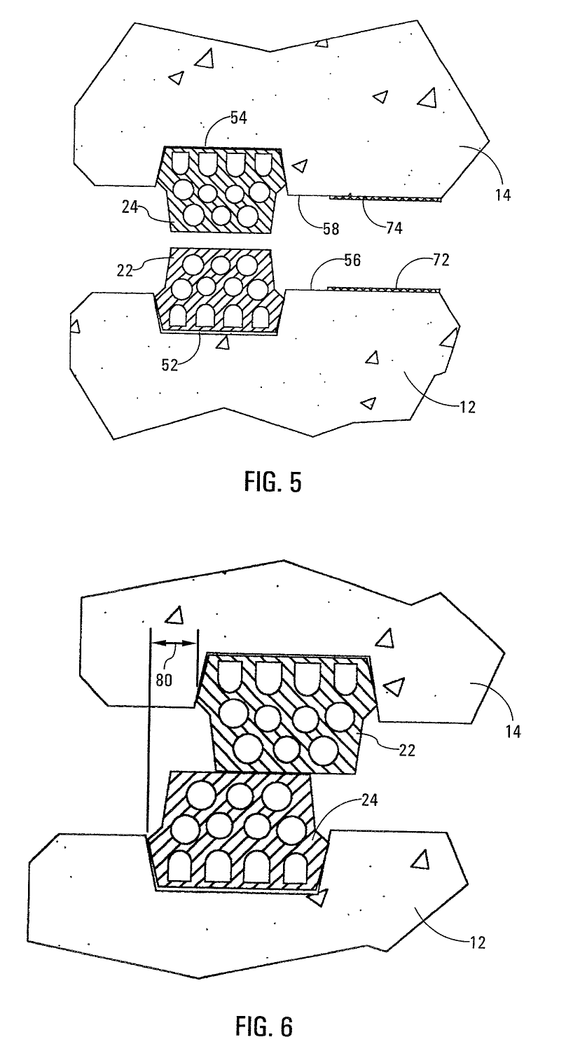

In the construction of a tunnel or pipe structure, the segments 12 and 14 are mechanically joined together, e.g., with bolts, and the sealing members 22 and 24 are pressed together. The elasticity or compressibility of the seal material and the space provided by the hollow regions 42 and 48 render the sealing members deformable under the loading or compression force. The energy of deformation provides a high pressure seal between the sealing faces 34 and 36. The adjacent segments are drawn together until a gap 70 between the surfaces 56 and 58 is closed or nearly closed. optionally, sheets or bands 72 and 74 of a conventional packing material are provided on surfaces 56 and 58, respectively, as illustrated in FIG. 5.

FIGS. 4 and 5 are depicted with opposing seals 22 and 24 in optimal alignment, however, it will be recognized that concrete casting or other part fabrication tolerances sometimes produce a degree of lateral offset or displacement 80 between the sealing pairs, as shown in FIG. 6. The sealing members in accordance with the invention are also advantageously employed when such an offset is present.

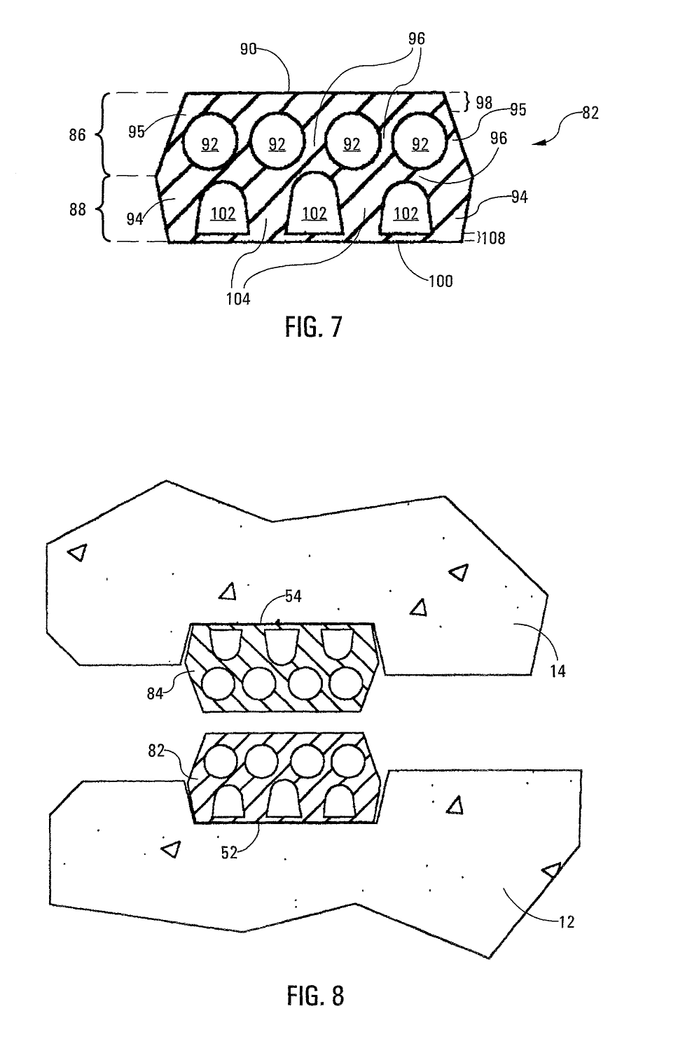

Referring now to FIG. 7, there is shown a cross-sectional view of a sealing member 82 in accordance with a second embodiment of the present invention. Seal 82 includes integral first and second portions 86 and 88, respectively. First portion 86 includes a sealing layer 98 having a generally planar sealing surface 90 which sealingly engages the facing sealing surface of an adjacent sealing member 84 (see FIG. 8) in the above-described manner. The first portion 86 further comprises a plurality of axially extending hollow regions 92 formed within the elongate body forming the sealing member 82, e.g., of circular cross-section. The hollow regions 92 are bounded by lateral sides 95, sealing layer 98, and structural partitions 96 which are defined therearound.

The second portion 88 comprises a base layer 108 having a generally planar surface 100 which is disposed opposite and arranged in a plane parallel to the sealing surface 90. The second portion 88 further comprises a plurality of laterally spaced apart and axially extending hollow regions 102. The hollow regions 102 define and are bounded by lateral side walls 94, structural partitions 104, and are closed off by the layer 108.

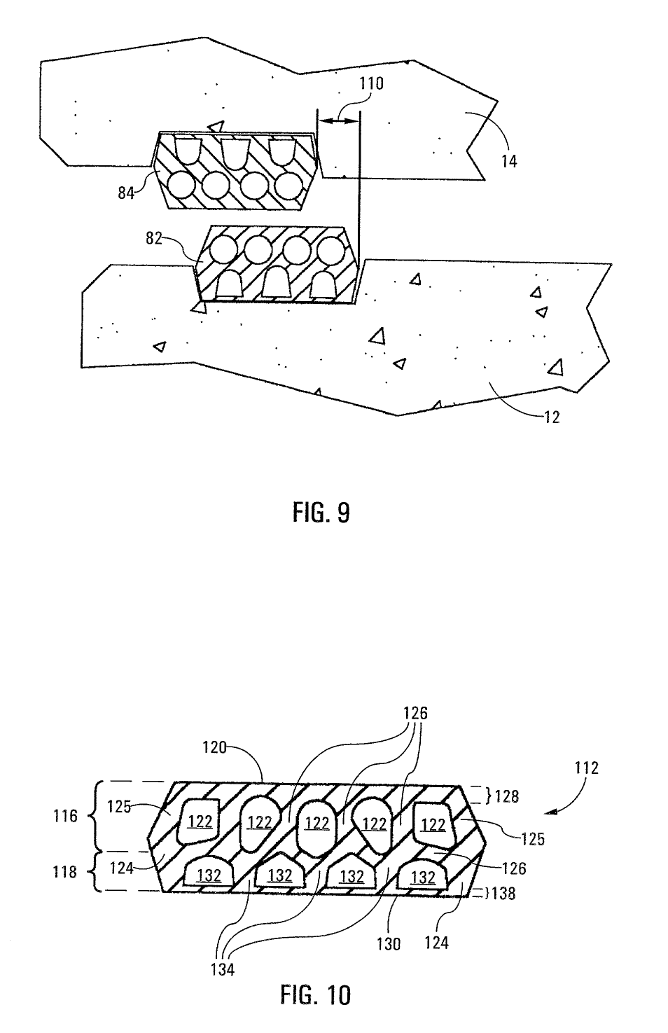

Referring now to FIGS. 8 and 9, there are shown pairs of adjacent support components 12 and 14, having the seals 82 and 84 affixed within recesses 52 and 54, respectively, in the manner described above by way of reference to FIG. 4. FIG. 8 depicts a well-aligned arrangement. FIG. 9 illustrates the sealing members 82 and 84 laterally offset by a distance 110. Optionally, a conventional packing material may be placed in the gap between the segments 12 and 14 prior to conjoining the segments as described above.

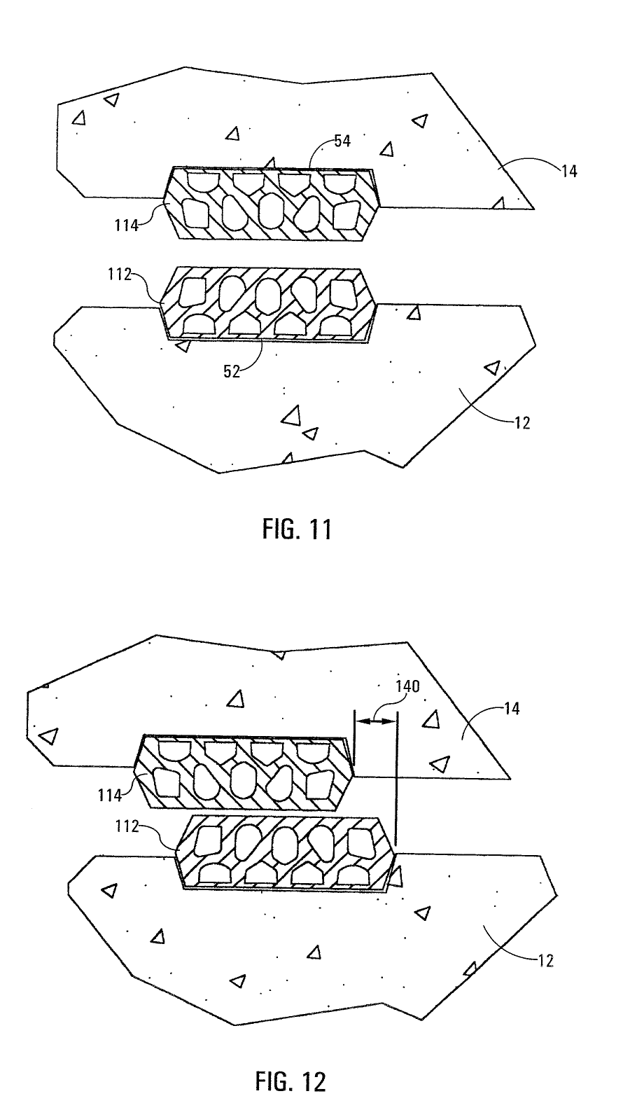

Referring now to FIG. 10, there is shown a cross-sectional view of a sealing member 112 in accordance with a third embodiment of the present invention. Seal 112 includes integral first and second portions 116 and 118, respectively. First portion 116 includes a sealing layer 128 having a generally planar sealing surface 120 which sealingly engages the facing sealing surface of an adjacent sealing member 114 (see FIG. 11) in the above-described manner. The first portion 116 further comprises a plurality of axially extending hollow regions 122. The embodiment of FIG. 10 illustrates some exemplary noncircular cross-sectional geometric configurations. The hollow regions 122 are bounded by lateral sides 125, sealing face 120, and structural partitions 126, defined therearound.

The second portion 118 comprises a base layer 138 having a generally planar surface 130 which is disposed opposite and arranged in a plane parallel to the sealing surface 120. The second portion 118 further comprises a plurality of laterally spaced apart and axially extending hollow regions 132. The hollow regions 132 define and are bounded by lateral side walls 124, structural partitions 134, and are closed off by the base layer 138.

Referring now to FIGS. 11 and 12, there are shown pairs of adjacent support components 12 and 14, having the seals 112 and 114 affixed within recesses 52 and 54, respectively, in the manner described above. FIG. 11 depicts a well-aligned arrangement. FIG. 12 illustrates the sealing members 112 and 114 laterally offset by a distance 140. Again, the optional use of a conventional packing material in the gap between the segments 12 and 14 is contemplated.

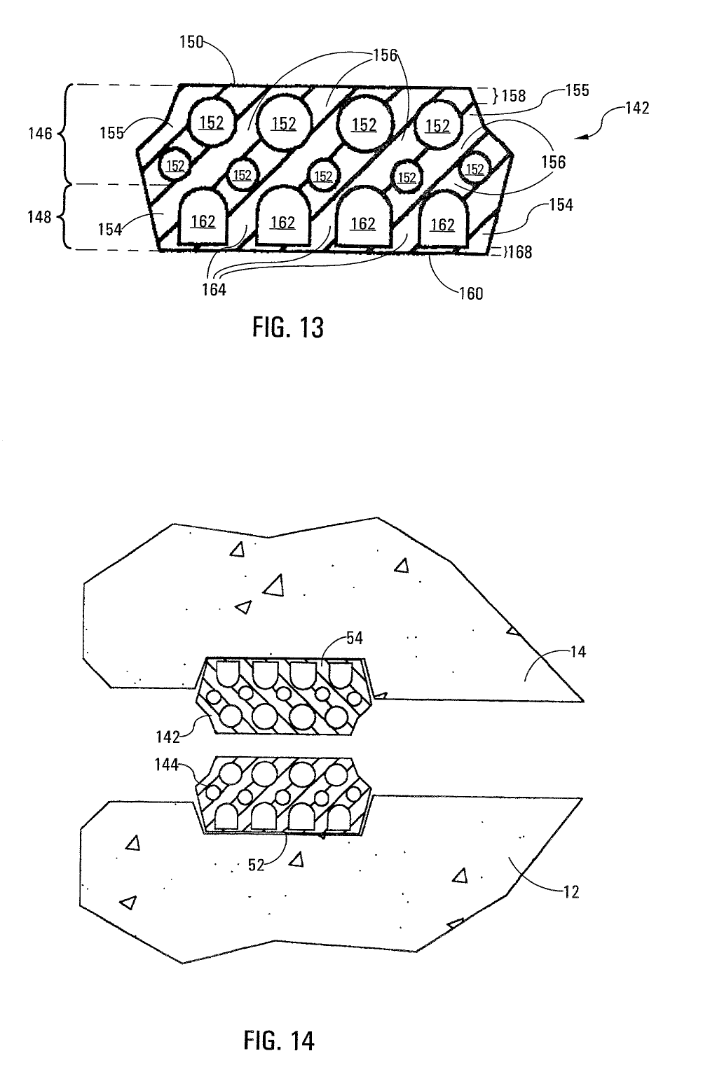

Referring now to FIG. 13, there is shown a cross-sectional view of a sealing member 142 in accordance with a fourth embodiment of the present invention. Seal 142 includes integral first and second portions 146 and 148, respectively. First portion 146 includes a sealing layer 158 having a generally planar sealing surface 150 which sealingly engages the facing sealing surface of an adjacent sealing member 144 (see FIG. 14) in the above-described manner. The first portion 146 further comprises a plurality of axially extending hollow regions 152 which are bounded by lateral sides 155, sealing face 150, and structural partitions 156 defined therearound.

The second portion 148 comprises a base layer 168 having a generally planar surface 160 which is disposed opposite and arranged in a plane parallel to the sealing surface 150. The second portion 148 further comprises a plurality of laterally spaced apart and axially extending hollow regions 162. The hollow regions 162 define and are bounded by lateral side walls 154 and structural partitions 164, with the spaced apart hollow regions 162 closed off by the base layer 168.

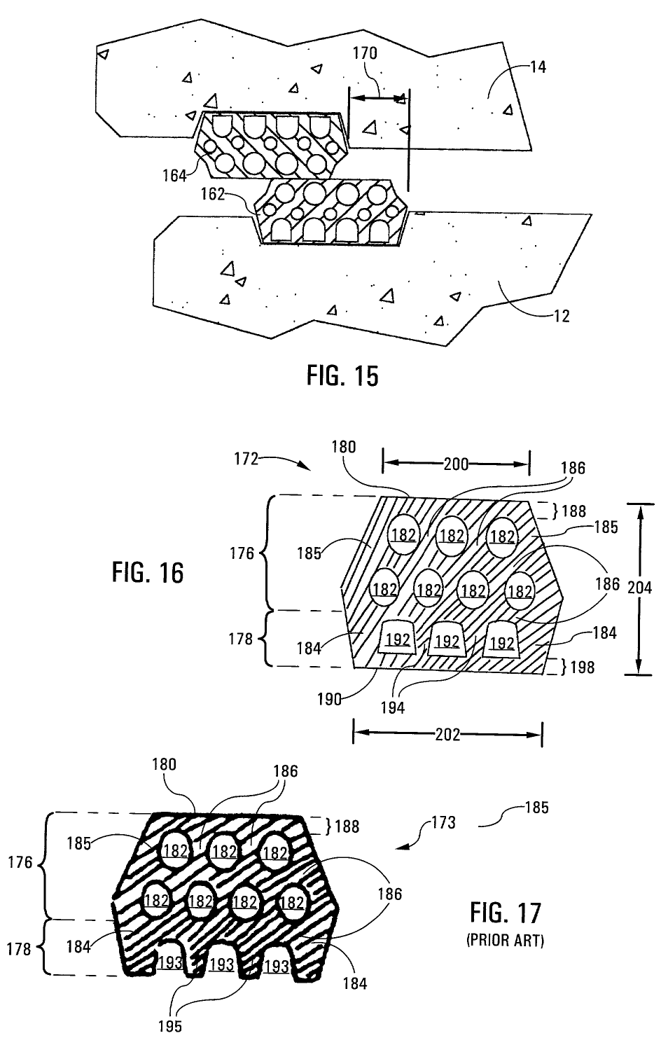

Referring now to FIGS. 14 and 15, there are shown pairs of adjacent support components 12 and 14, having the seals 142 and 144 affixed within recesses 52 and 54, respectively, in the manner described above. FIG. 14 depicts a well-aligned arrangement. FIG. 15 illustrates the sealing members 142 and 144 laterally offset by a distance 170. Again, the optional use of a conventional packing material in the gap between the segments 12 and 14 is contemplated.

### EMPIRICAL TESTS

The following comparative tests have been made to demonstrate the high pressure capability of the subject invention. Water pressure tests were performed by applying pressure to the interior volume of two gaskets in a picture frame configuration placed in gasket grooves or recesses in steel plates. The dimensions of the grooves were 1.4 cm deep and 3.5 cm wide at the base, with side slopes of 1 horizontal to 4 vertical. The picture frame dimensions of the gasket grooves were 10.2 cm×45.7 cm, measured inside to inside at the bottom of the groove. The grooves were made by bolting machined plates to larger plates that were 5.1 cm×27.9 cm×63.5 cm. Two holes were tapped in the top plate for applying water pressure and for allowing air to escape in order to fill the cavity with water.

The gaskets were compressed by placing the steel plates with the gasket grooves between steel plates that were pulled together with 8 threaded 2.5 cm diameter rods. In one set of tests, the plates with the threaded rods that compressed the gaskets consisted of two plates at the top and two at the bottom, each with dimensions 3.8 cm×22.9 cm ×48.3 cm. In subsequent tests, the loading system was modified to increase stiffness by placing four.8 cm×22.9 cm×48.3 cm steel plates at the bottom and a steel plate with dimensions 5.7 cm×58.4 cm×61.0 cm at the top.

Pressure was applied from a nitrogen tank that was compressed to 170 kg/cm² with the gas applied to the top of another nitrogen bottle that was filled with water. A line was connected to the bottom of the water bottle through a fitting that was installed by drilling and tapping a hole.

The line was connected to the gasket cavity. All the lines and fittings were designed for 700 kg/cm² hydraulic pressure. A gas regulator was placed at the outlet of the nitrogen bottle to reduce the pressure and regulate it to the desired the desired values in the water. The water pressure was measured with a digital gas pressure gage with an accuracy of +/−0.25%.

The gasket cross-section geometry used in these tests is shown in FIGS. 16 and 17. Referring to FIG. 16, there is shown a gasket 172 according to a fifth embodiment of the present invention which includes integral first and second portions 176 and 178, respectively. First portion 176 includes a sealing layer 188 having a generally planar sealing surface 180 which sealingly engages the facing sealing surface of an adjacent sealing member in the manner described above. The first portion 176 further comprises a plurality of axially extending hollow regions 182 which are bounded by lateral sides 185, sealing face 180, and structural partitions 186 defined therearound.

The second portion 178 comprises a base layer 198 having a generally planar surface 190 which is disposed opposite and arranged in a plane parallel to the sealing surface 180. The second portion 148 further comprises a plurality of laterally spaced apart and axially extending hollow regions 192. The hollow regions 192 define and are bounded by lateral side walls 184 and structural partitions is 194 and are closed off by the base layer 198. For the tested gaskets, the transverse width 200 of the sealing surface 180 was 30 mm, the transverse width 202 of the base surface 190 was 34 mm, and the height 204 of the gasket was 26 mm.

FIG. 17 shows the cross-sectional geometry of a gasket 173 used in the comparative tests. The comparative gasket 173, which is exemplary of the prior art, includes a first portion 176 as described above by way of reference to FIG. 16, and a second portion 179 which differs from the gasket 172 of the subject invention in that it lacks the base layer 198 (see FIG. 16). That is to say, second portion 179 of the gasket 173 includes a plurality of axial grooves 193 which are bounded by lateral sides 184 and partitions 195, forming channels that open to the exterior of the gasket.

The tested gaskets 172 and 173 were formed from polyisoprene. The total load on the gaskets was measured with two load cells placed between the top steel plate with the gasket groove and the top plate with the threaded rods. Extrusion of the gasket into the gap was measured with a 0.001 mm dial gage with the plunger inserted horizontally into the gap at the middle of the long side of the gasket. Change in the gap was measured with two 0.01 mm dial gages placed between the top and bottom steel plates, one at each end. These gap measurements were augmented with measurements using a digital micrometer with 0.001 mm accuracy at each corner and at the middle of each side.

To determine the relationship between the water pressure and the gasket contact pressure, it was necessary to subtract the water pressure load from the total load given by the load cells. To determine the water pressure load, it is necessary to estimate the area over which the water acts. The area over which the water acts was taken as the dimensions inside the top of the gasket groove, or 425.9 square centimeters. Once the load on the gasket was calculated, the area of the gasket was needed to determine the gasket contact pressure. It was assumed that the gasket was compressed so that it had the width corresponding to the top of the gasket groove, which provided a gasket area of 528.8 square centimeters.

The load-deformation tests of the gaskets were performed in the same device that consisted of two steel bars that were 5.1 cm×12.7 cm×454.7 cm with longitudinal plates bolted on each side of one face to form the gasket grooves. All the plates were machined to provide accurate dimensions of the groove that were 1.4 cm deep and 3.5 cm inches wide at the base, with side slopes of 1 horizontal to 4 vertical. Plates were bolted to the ends of one of the steel bars to prevent longitudinal extrusion of the gaskets. On each of the steel bars opposite to the grooves, a 3.8 cm ×12.7 cm×10.2 cm steel bar was welded perpendicular to the side that could be placed in the grips of a testing machine.

The tests were performed by clamping the protruding 3.8 cm×12.7 cm×10.2 cm bars into the heads of a 50-KIP (10⁵ kg) MTS hydraulic testing machine with the gaskets bonded in place. The swivel heads of the machine were then adjusted so that the faces of the bars containing the gasket grooves were parallel and the heads were locked to prevent rotation. The gaskets were then brought into contact and the gap was measured. The load-deformation curve was continuously recorded with a computer. The rate of loading was programmed on an Instron controller that controlled the testing machine head movement linearly with time at a specified rate and to a specified gap.

### RESULTS

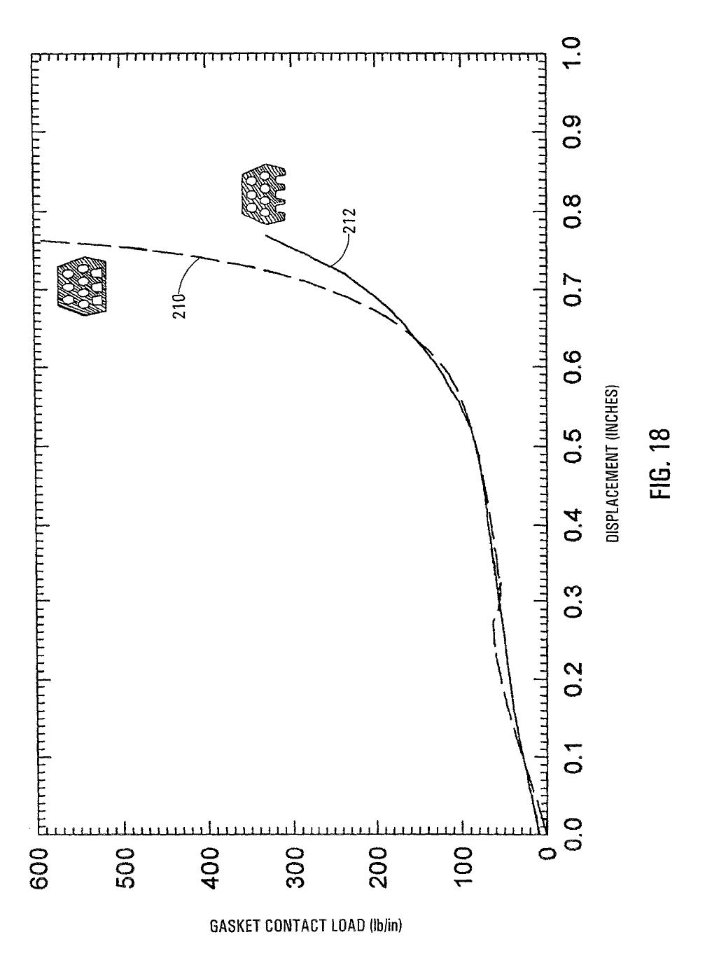

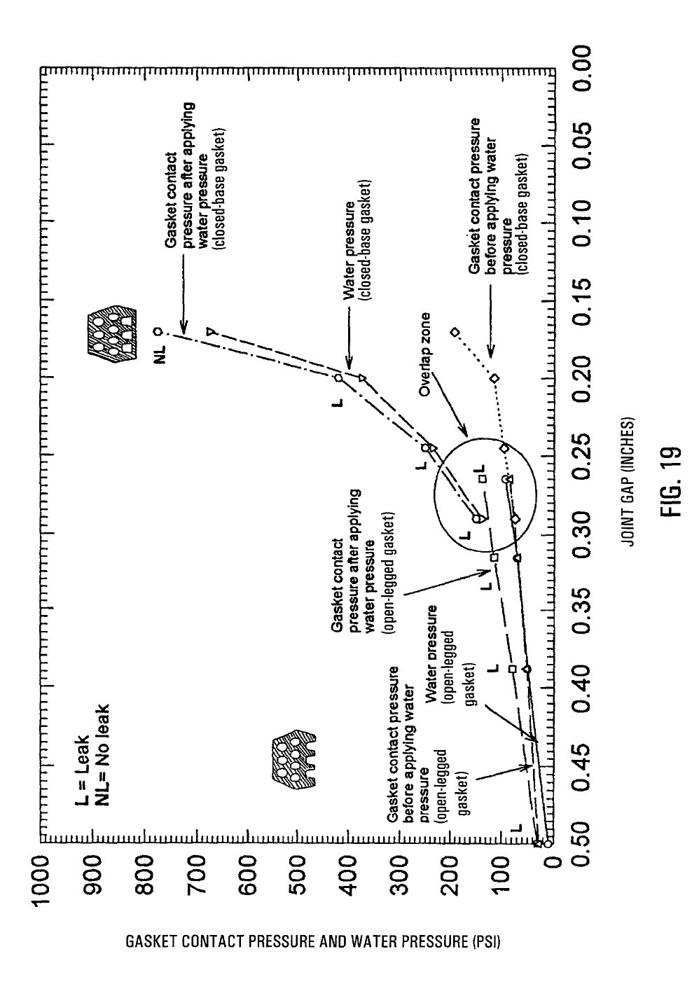

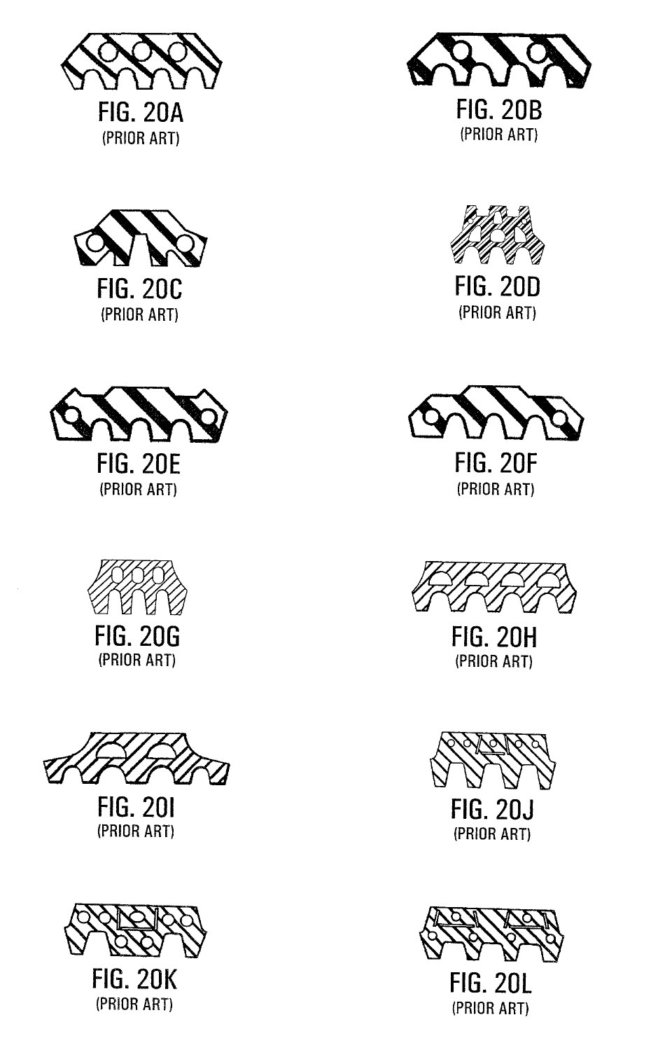

Differences in sealant behavior and capacity between the open-legged gasket illustrated in FIG. 17 and the closed-base gasket in accordance with the invention and illustrated in FIG. 16 were observed, even though they have similar load deformation characteristics. FIG. 18 shows load-deformation curves 210 and 212 for the closed- and open-base gaskets, respectively. FIG. 19 is a graph showing the relation between gasket contact pressure before and after applying water pressure, and water pressure at leakage as a function of joint gap for both gaskets. As shown in FIG. 19, leakage occurred at the initial gasket contact pressure for the open-leg gasket, while leakage occurred near the final gasket contact pressure for the closed-base gasket. The final contact pressure for the closed-base gasket was much higher than the initial contact pressure, leading to higher a leakage pressure.

The differences in sealant behavior between the open-legged gasket and the subject gasket appear to be a result of the difference in the base condition of the two gaskets. Leakage occurred between the contact faces of the adjoining gaskets of the present invention. In contrast, leakage occurred between the gasket groove and the gasket for the conventional open leg gasket. It is expected that the differences in sealant behavior between the two types of gasket lie in the behavior of the legs as the lateral water pressure is applied. The lateral water pressure on the first leg of the open-leg gasket causes the bond to fail at the bottom of the leg and pushes the leg laterally causing it to buckle. This reduces the stiffness of the gasket above the leg and allows water to pass into the cavity between the legs, reaching the second leg which is then forced to buckle in the same way. This type of progressive deformation of the legs reduces the stiffness of the gasket and allows leakage to occur between the gasket and bottom of the gasket groove, as observed in the tests. Such behavior caused the conventional gasket to leak at water pressure less than the gasket-to-gasket contact pressure. When the open-leg gasket tests were disassembled, the openings between the legs were full of water.

For the closed-leg gasket of the present invention, water was not allowed to pass the first leg of the closed-base gasket, thus preventing the progressive leg failures found with the open-legged design. With the larger bonding surface of the closed bottom, water did not pass under the gasket. In the tests, all the leakage occurred at the gasket-to-gasket interface. When the closed-base gasket tests were disassembled, the gasket bond to the groove was intact and the contact between the groove and gasket base was dry.

The description above should not be construed as limiting the scope of the invention, but as merely providing illustrations to some of the presently preferred embodiments of this invention. In light of the above description and examples, various other modifications and variations will now become apparent to those skilled in the art without departing from the spirit and scope of the present invention as defined by the appended claims. Accordingly, the scope of the invention should be determined solely by the appended claims and their legal equivalents.

What is claimed is:

1. A sealing member having an elongate body formed of an elastomeric material, comprising:
a generally planar sealing surface adapted to provide an outward sealing force in a direction generally perpendicular to said sealing surface;
a plurality of longitudinally extending hollow regions formed within the sealing member, said hollow regions bounded at least in part by longitudinally extending and transversely spaced apart structural partitions; and
a layer of elastomeric material on a side opposite the sealing surface spanning said structural partitions and enclosing said hollow regions.

2. The sealing member according to claim 1, wherein at least one of said plurality of hollow regions has a generally U-shaped cross-section.

3. The sealing member according to claim 1, wherein said plurality of hollow regions comprises a first set of transversely spaced apart hollow regions adjacent said layer of elastomeric material and a second set of transversely spaced apart hollow regions adjacent said sealing surface.

4. The sealing member according to claim 3, wherein at least one hollow region of said first set has a generally U-shaped cross-section, and at least one hollow region of said second set has a generally circular cross-section.

5. The sealing member according to claim 4, further comprising a third set of transversely spaced apart hollow regions disposed between said first and second sets, wherein at least one hollow region of said third set has generally circular cross-section.

6. The sealing member according to claim 1, wherein the sealing member has a polygonal transverse section.

7. The sealing member according to claim 1, wherein the sealing member has a hexagonal transverse section.

8. The sealing member according to claim 1, wherein the layer of elastomeric material has a smaller cros-sectional thickness than said structural partitions.

9. A sealing member for sealing a gap between a first structural part and a second structural part, the sealing member comprising an elongate member of an elastomeric material, comprising:
a first portion comprising a sealing surface providing a seal acting in a direction projecting toward the second structural part to provide a sealing interference between the two parts when the sealing member is installed on the first part and the second structural part is secured to the first part;
said first portion comprising at least one longitudinally extending channel;
a second portion for engaging a recess defined peripherally about the first structural part;
said second portion comprising at least one longitudinally extending channel;
said second portion further comprising an engaging surface which forms a continual and uninterrupted abutment with a surface of said first structural part.

10. A seal arrangement comprising:
first and second abutting structural parts, said structural parts being segments of a type that are assembled to form a tubular tunnel with a formation of transverse joints and longitudinal joints, each segment having a mating side and being provided on the mating side with at least one peripheral recess covering all mating sides of the segment;
a sealing member made of an elastomeric material for sealing and bridging a gap between the two structural parts, said sealing member extending in the form of an elongate body located in each recess;
wherein said sealing member comprises integral first and second portions;
said first portion comprising a first sealing surface engaging a second sealing surface belonging to another sealing member located on the second structural part to provide a sealing interference therebetween, wherein the first and second sealing surfaces are in facing relation and substantial alignment when the first structural part is secured to the second;
said second portion comprising a plurality of longitudinally extending hollow regions formed within the sealing member, said hollow regions bounded at least in part by longitudinally extending and transversely spaced apart structural partitions, and a layer of elastomeric material on a side opposite the sealing surface spanning said structural partitions and enclosing said hollow regions.

11. The seal arrangement of claim 10, wherein the first and second structural parts are made of a material s selected from the group consisting of concrete, steel, reinforced concrete, and cast iron.

12. In a method for producing a seal of a type for sealing a gap between first and second structural parts carrying a seal, comprising producing a elongate gasket made of an elastically compressible material comprising a generally planar sealing surface adapted to provide an outward sealing force in a direction generally perpendicular to said sealing surface, and a plurality of longitudinally extending hollow regions formed in the sealing member, said hollow regions bounded at least in part by longitudinally extending and transversely spaced apart structural partitions, wherein a process selected from molding and extrusion is used for producing the elongate gasket, the improvement comprising:
producing, at the same time the elongate gasket is being produced, a layer of elastomeric material on a side opposite the sealing surface spanning said structural partitions and enclosing said hollow regions.

13. A method for increasing the sealing pressure of a seal sealing a gap between first and second structural parts, said structural parts being segments of a type that are assembled to form a tubular tunnel with a formation of transverse joints and longitudinal joints, each segment having a mating side and being provided on the mating side with at least one peripheral recess covering all mating sides of the segment, the method comprising the steps of:
providing first and second sealing members, said first and second sealing members comprising first and second generally planar sealing surfaces, respectively;
forming a plurality of longitudinally extending hollow regions within said first and second sealing members, said hollow regions bounded at least in part by longitudinally extending and transversely spaced apart structural partitions;
providing on the first and second sealing members a layer of elastomeric material on a side opposite the sealing surface spanning said structural partitions and enclosing said hollow regions;
installing the first sealing member so that it is positioned within said at least one peripheral recess of the first segment;
installing the second sealing member so that it is positioned within said at least one peripheral recess of the second segment;
aligning the first segment relative to the second segments such that said first and second sealing surfaces are substantially aligned in facing relation; and
securing the first and second segments to compress the first and second sealing members and to provide a sealing pressure between said first and second sealing surfaces.

14. A construction article comprising:
a support component having a recess defined about a peripheral edge; and
a sealing member having an elongate body formed of an elastomeric material, the sealing member comprising:
a generally planar sealing surface adapted to provide an outward sealing force in a direction generally perpendicular to said sealing surface,
a plurality of longitudinally extending hollow regions formed within the sealing member, said hollow regions bounded at least in part by longitudinally extending and transversely spaced apart structural partitions, and
a layer of elastomeric material disposed opposite the sealing surface and engaging said recess, the layer spanning said structural partitions and enclosing said hollow regions.

15. The construction article according to claim 14, wherein the support component comprises an arched concrete tunnel segment.

16. The construction article according to claim 14, wherein at least one of said plurality of hollow regions has a generally U-shaped cross-section.

17. The construction article according to claim 14, wherein said plurality of hollow regions comprises a first set of transversely spaced apart hollow regions adjacent said layer of elastomeric material and a second set of transversely spaced apart hollow regions adjacent said sealing surface.

18. The construction article according to claim 17, wherein at least one hollow region of the first set has a generally U-shaped cross-section and at least one hollow region of the second set has a generally circular cross-section.

19. The construction article according to claim 18, further comprising a third set of transversely spaced apart hollow regions disposed between said first and second sets, wherein at least one hollow region of said third set has a generally circular cross-section.

20. The construction article according to claim 14, wherein the sealing member has a polygonal transverse section.

21. The construction article according to claim 14, wherein the sealing member has a hexagonal transverse section.

22. The construction article according to claim 14, wherein the layer of elastomeric material has a smaller cros-sectional thickness than said structural partitions.
